(19) United States
(12) Patent Application Publication
(10) Pub. No.: US 2024/0077139 A1
(43) Pub. Date: Mar. 7, 2024

(54) MECHANICAL SEAL FOR ROTATING SHAFT

(71) Applicant: Roplan Sales Inc., Madison, WI (US)

(72) Inventor: Karl Johan WESTIN, Madison, WI (US)

(21) Appl. No.: 17/903,469

(22) Filed: Sep. 6, 2022

(51) Int. Cl. F16J 15/34; F16J 15/40

(52) U.S. Cl. CPC F16J 15/3452; F16J 15/3412; F16J 15/40

(57) ABSTRACT

One or more techniques and/or systems are disclosed for a mechanical seal that can be used on a rotating shaft. The seal provides for much longer service life, improved sealing properties, which can reduce maintenance, downtime, and cost for the operator, improved performance against pressure and vacuum, isolation of a target process, and may be operated at full motor speeds, while reducing wear on the shaft. The seal comprises a stationary portion that interfaces with a dynamic portion. The dynamic portion is operably affixed to the rotating shaft, and the static portion provides a face seal to mitigate leakage therebetween.

### BACKGROUND

Mixers and agitators (e.g., and other equipment) used in commercial applications can utilize a rotating shaft to perform the target operation, such as mixing components. In some application, it may be desirous to seal the target operation such that the components are not spilled or leaked from the equipment during mixing, outside contaminants are not introduced into a mixing operation, and/or such that a vacuum or pressure can be applied during operation. Sealing around the rotating shaft can provide a challenge that is often accomplished using lip seals made from some elastomeric component. However, lip seals are susceptible to rapid wear, which can lead to a broken seal, ongoing replacement and maintenance, and higher costs; and are further not typically able to maintain any vacuum, and only minimal positive pressure.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a mechanical seal that can be used on a rotating shaft. As described herein, the innovative design of the seal provides a simple yet effective design that allows for much longer service life, which can reduce maintenance, downtime, and cost for the operator, and provide for improved sealing properties. Further, the improved seal provides for an improvement in performance against pressure (e.g., pressures greater than zero up to about 10 psi) and vacuum (e.g., slight vacuum), can isolate a target process, and may be operated at full motor speeds, while reducing wear on the shaft. Additionally, the improved seal may be used in regulated sanitary operations, as it can be appropriately cleaned between operations, such as in place.

In one implementation of a mechanical seal device for providing a fluid seal for an apparatus that uses a rotating shaft, a seal housing can comprise an annular plate body with a centrally disposed first opening. The seal housing can further comprise a first side and a second side, and a centrally disposed cavity at the second side that has a diameter larger than the central opening. Further, the example seal device comprises a static seal that comprises an annular body with a centrally disposed first opening. The static seal can comprise a first end and a second end, where the first end is engaged with a spring disposed in the central cavity of the seal housing. The second end is disposed at an opposite end of the first end, and the spring is operably biasing the static seal away from the seal housing. Additionally, a rotary seal can comprise an annular plate body with a central opening. The rotary seal can comprise a first side and a second side, with the first side engaged with the second end of the static seal. In this implementation, a sleeve comprises a tube-shaped body that is sized to operably seat upon a shaft of a target apparatus, with a first end and second end, where the second end is fixedly engaged the rotary seal.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIGS. 1A, 1B and 1C are component diagrams illustrating an example implementation of a mechanical seal that can be used in mixing operations.

FIGS. 2A and 2B are component diagrams illustrating a cut-away view of one or more portions of one or more systems described herein.

FIG. 3 is a component diagram illustrating an exploded view of an implementation of one or more portions of one or more systems described herein.

FIGS. 4A and 4B are component diagrams illustrating a cut-away view of one or more portions of one or more systems described herein, in an example implementation.

FIG. 5 is a component diagram illustrating an exploded view of one or more portions of one or more systems described herein, in an example implementation.

FIG. 6 is a component diagram illustrating an example implementation of a tool that may be used to assemble a mechanical seal described herein.

FIG. 7 is a component diagram illustrating an example implementation of one or more portions of one or more devices described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As disclosed herein, in one aspect, a mechanical seal can be devised that may be used on a rotating shaft to provide sealing properties to a container in which a target operation is underway. In one implementation in this aspect, the mechanical seal can be designed to be used in top entry mixer/agitator equipment, in place of a lip seal. That is, for example, the described mechanical seal can comprise a simple design with a low profile, that can fit into typical lip seal locations, most often with little modification. Further, in some implementations, it can be designed with features that allow it to meet requirements of 3A and ASME BPE standards and EHEDG guidelines, which are used for sanitary conditions (e.g., food preparation). That is, for example, in this aspect, the described seal may be appropriate for clean-in-place (CIP) operations, and even steam-in-place (SIP) operations. In this way, the described mechanical seal offers the same advantages of a lip seal, with greater performance and operational advantages. Currently, lip seals are commonly used in these types of applications because they (a) can be designed in to meet aforementioned standards and guidelines, (b) create a hermetic seal and (c) are low cost. However, the lip seals are made of a polymeric (e.g., PTFE) or elastomeric material that rapidly wears and breaks down after a limited time (e.g., could be within hours or days), necessitating replacement to ensure process integrity.

In this aspect, for example, the mechanical seal described herein will operate for significantly longer periods of time (e.g., months-years) under the same conditions, thus decreasing equipment downtime and costs for seal replacement. The design is simple, compared to traditional mechanical seals, and has a low profile, so it can replace a lip seal in these operations. Additionally, in this aspect, the seal described herein is also capable of operating at higher motor speeds, which may allow for elimination of a gear box to reduce speeds, resulting in additional savings for the system design and operation. Further, the seal described herein can used in operations having a wider range of pressures/vacuum than current seals, and may be used in conditions with incidental liquid product contact. Historically, it was very difficult for mechanical seal designs used in these types of applications to meet sanitary/hygienic design requirements described above, and they are significantly more costly. However, the mechanical seal described herein can be used to replace typical lip seals, can meet the hygienic requirements, and can last longer than current seals in these types of applications.

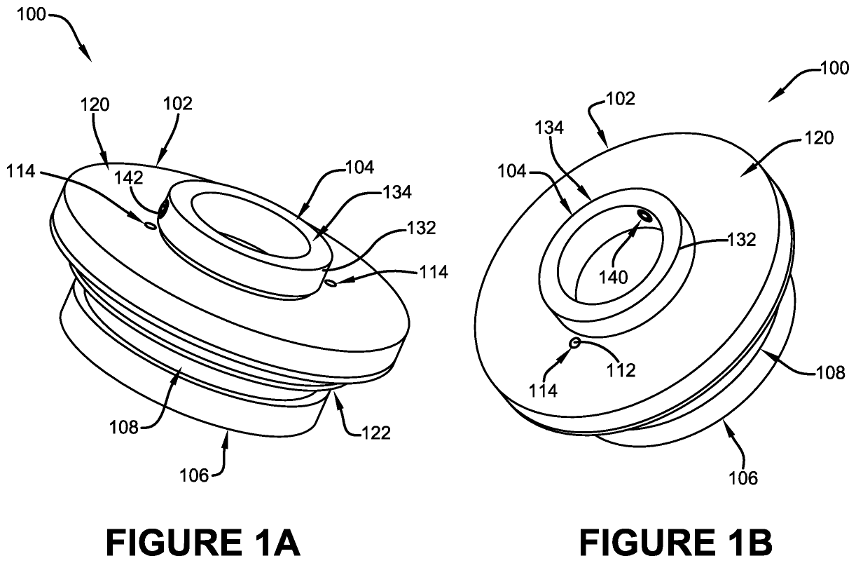

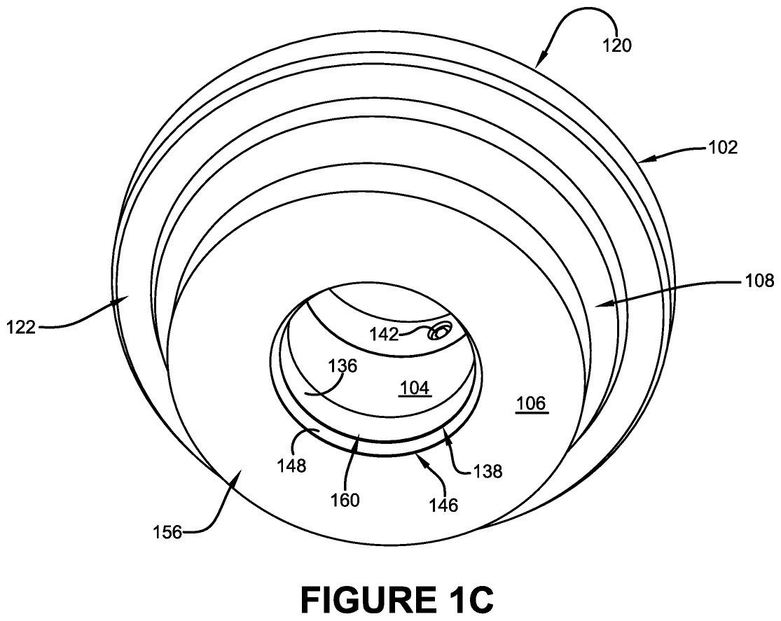

FIGS. 1A-C, 2A, 2B, and 3 illustrate one implementation of an example mechanical seal that can be used for a rotating shaft, in various views. In this implementation, the example seal 100 can comprise seal housing 102 (e.g., a.k.a. gland plate or gland ring) and a sleeve 104 which can be press fit into a rotary seal 106 (e.g., or dynamic seal, or mating ring). A dynamic face 164 of the rotary seal 106 operably engages with a stationary face 166 of a static seal 108 (e.g., stationary or seal ring), and a biasing spring 110 (e.g., a wave spring) operably provides a biasing force against the static seal 108 that normally biases the static seal 108 against the rotary seal 104. One or more pins 112 (e.g., or other types of fasteners, such as bolts, screws, etc.) can be disposed through an opening 114 in the seal housing 102 and into a shaft opening 116 in the static seal 108 to operably engage the two components together to mitigate rotation of the seal housing 102 and static seal 108 when installed in a mixing system, for example. In some implementations, the opening 114 may be a through-hole, through the seal housing; in other implementations, the opening 114 may be a blind opening that is closed at the top (first side 120), and open at the bottom (second side 122). As an example, the seal housing 102 can be fixedly engaged in a mixing device, and the pins 112 can hold the static seal 108 to mitigate rotation with respect to the seal housing 102.

As illustrated, housing 102 comprises a first side 120 and a second side 122. In some implementations, the first side 120 installed into a target device (e.g., product mixer or other device with a rotating shaft) facing upward, and the second side 122 may be install facing downward. In other implementations, the second side 122 may be installed facing upward, and the first side 120 may be installed facing downward. That is, for example, the orientation of the seal 100 may be dependent on its use and location in the target device, and a top and bottom of the seal may be dependent on installation.

Further, as illustrated in this implementation, the housing 102 can comprise first and second gasket channels 124, 126 at the second side 122, on opposing faces. The first and second gasket channels 124, 126 can be configured to operably hold a first and second gasket 128, 130 (e.g., O-rings), where the first gasket 128 is a dynamic gasket (e.g., dynamic O-ring) that can be subjected to potential translation of the static seal 108 during operation (e.g., vertically and/or laterally) and the second gasket 130 is a static gasket (e.g., not typically subjected to movement during operation). The first gasket 128 can operably provide a seal between, and be engaged with, the outside of the static seal 108 and the inside of the housing 102, and the second gasket 130 can provide a seal between, and be engaged with, the outside of the housing 102 and a portion of the target device into which the seal 100 is installed.

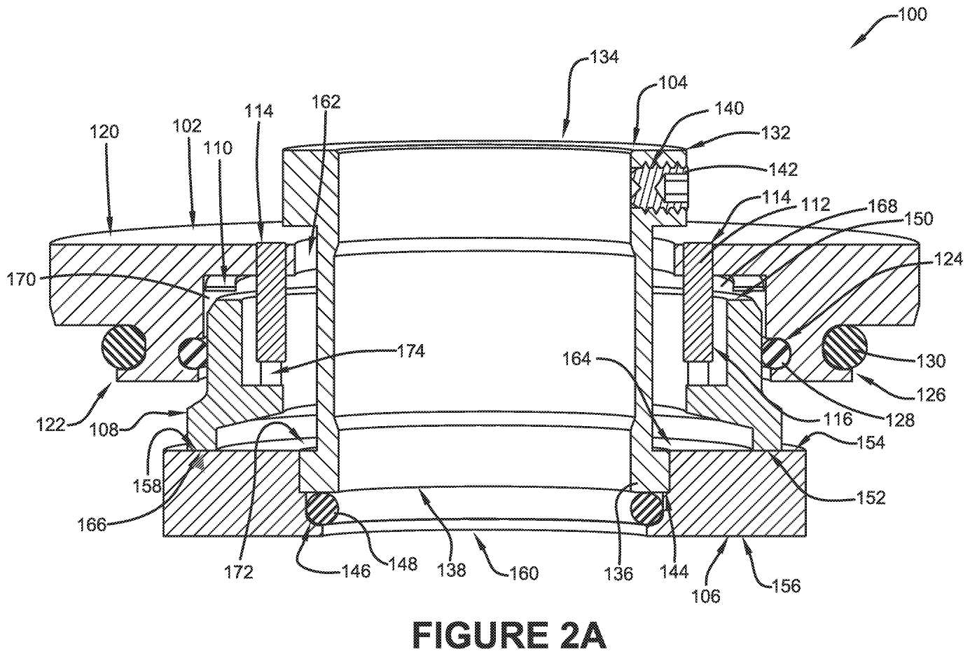

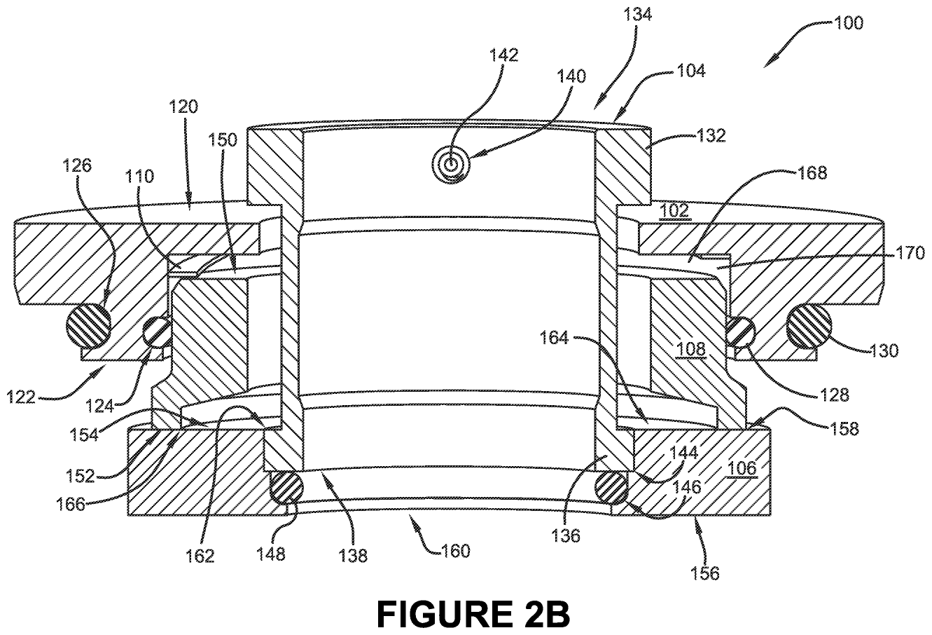

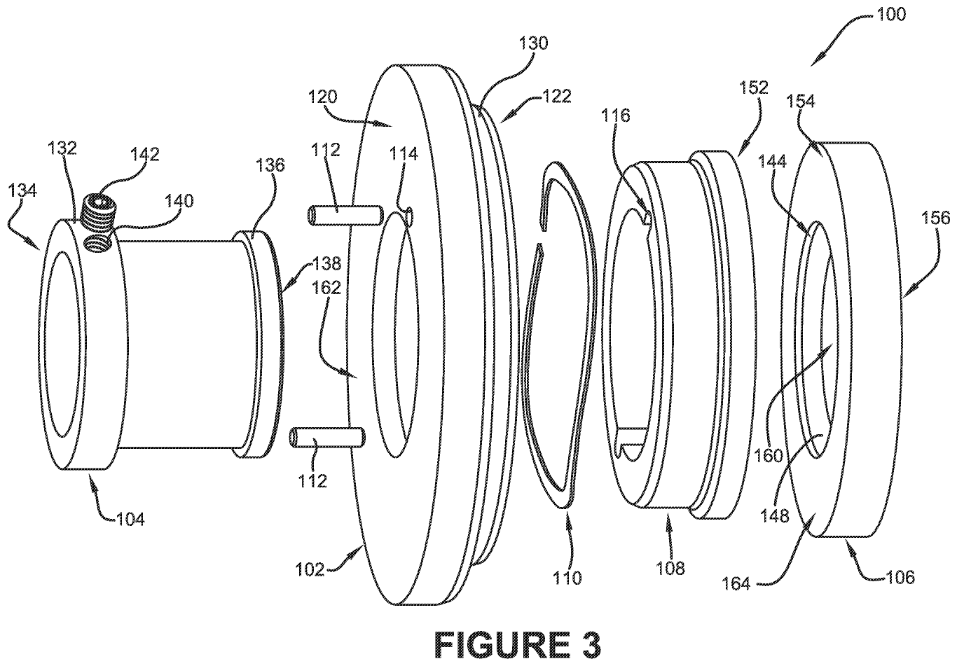

As illustrated, in FIGS. 1-3, the sleeve 104 comprises a first shoulder 132 at a first end 134 and a second shoulder 136 at a second end 138. The first shoulder comprises a fastener opening 140 that is configured to receive a fastener 142, such as a set screw. The internal diameter of the sleeve is configured to operably receive a shaft of at target missing device. In some implementations, the internal diameter of the sleeve 104 can be formed with a dimension that can accommodate the target device's shaft, which may be different for different device shafts. As an example, the fastener 142 can be used to fasten the sleeve 104 of the seal 100 to a shaft of the target mixing device. In this example, the shaft of the device can be operably rotating, and the fastened sleeve 104 will thus rotate with the shaft. The sleeve 104 is fixedly engaged with the rotary seal 106, such as by using a force fit, shrink fit, interference fit, or other, appropriate fastening method. Therefore, the rotary seal 106 can operably rotate with the sleeve 104 and shaft, for example.

Further, the rotary seal 106 comprises a shoulder 144 that provides a stop for the sleeve 104 when fixed together. That is, the shoulder forms an opening with a smaller diameter than that of the second shoulder 136 of the sleeve 104. Additionally, the rotary seal 106 can comprise and internal gasket channel 146 disposed at the second end 138 of the sleeve 104, that is configured to hold a third gasket 148 therein. In this implementation, the third gasket 148 can comprise a static gasket that forms a seal between, and is engaged with, the rotary seal 106, the sleeve 104, and the shaft of the target device.

When the seal 100 is fully assembled, a biasing spring 110 is disposed between, and engaged with, a first end 150 of the static seal 108 and the second side 122 of the seal housing 102. In operation, the biasing spring normally biases the static seal 108 away from the seal housing 102, and toward the rotary seal 106. In this way, for example, a second end 152 of the static seal 108, at the stationary seal 166, can be physically engaged with a first side 154 of the rotary seal 106, at the dynamic face 164, under a biasing force created by the biasing spring 110. Further, the engagement of the stationary seal 166 of the static seal 108 with the dynamic face 164 of the rotary seal 106 forms a seal 158 (e.g., a.k.a. 164 and 166 comprise lapped seal faces to form the seal 158) between the two to mitigate migration of fluid across the formed seal.

As illustrated, the first side 154 of the rotary seal 106 is substantially planer, and the second end 152 of the static seal 108 is substantially planer. In operation, for example, the first side 154 of the rotary seal 106 will rotate (e.g., translate in a circular direction) with respect to the second end 154 of the static seal 108. In some implementations, the static seal 108, or at least a portion of the second end 152 of the static seal 108, can be comprised of a material that provides lubricity, such as one that contains a polymer, graphite, or combinations thereof. In this way, for example, friction can be reduced, lubrication can be provided, wear may be reduced, and an improved seal can be provided.

In some implementations, the seal 100 can be assembled by disposing the first gasket 128 in the first gasket channel 120 of the housing, and disposing the second gasket 130 in the second gasket channel 126 of the housing 102. The biasing spring 110 can be disposed in a cavity 170 formed at the second side 122 of the housing. The static seal 108 can be placed in the cavity 170 with its first end 150 engaged with the biasing spring 110, and its second end 152 disposed outside of the cavity 170, with the body of the static seal 108 engaged with the first gasket 128. In some implementations, a lubricant/protectant, such as a grease appropriate for the gasket material (e.g., and O-ring grease), can be applied to the first gasket 128, at least at its interface with the body of the static seal 108. In this way, for example, due to the dynamic nature of this first gasket 128 (e.g., dynamic O-ring), the lubricant/protectant can help reduce friction and wear, and improve the sealing quality and life of the first gasket 128.

In continuation of the assembly of the seal 100, pins 112 can be inserted into the respective pin opening 114 in the housing 102, and into the appropriate pin opening 116 of the static seal 108. As one example, a slotted spring pin (e.g., or something similar) may be used to provide a force fit of the pin 112 in the respective openings 114, 116. That is, the diameter of the pin 112 can be reduced by forcing it into the opening 114, 116, and the normal outward bias of the slotted spring pin can provide an appropriate force fit. As illustrated, the respective pins 112 may not be inserted all the way into the pin opening 116 of the static seal 108. A clearance 166 can be formed between the pin 112 and the end of the pin opening 116 in the static seal 108. In this way, for example, the clearance 166 in the pin opening 116 can provide adequate space for potential translation of the static seal 108 (e.g., vertically) during operation.

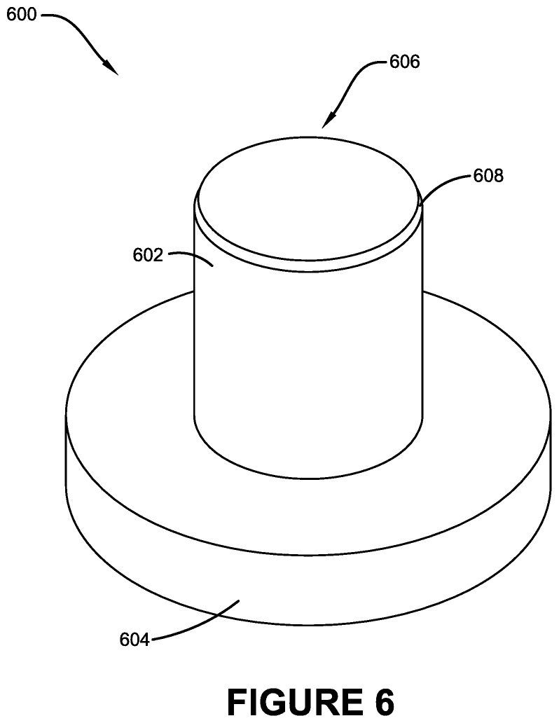

In this example, to continue assembly of the seal 100, the third gasket 148 can be disposed in the internal gasket channel 146 of the rotary seal 106. The second shoulder 136 of the sleeve 104 can be inserted through an internal opening 162 in the housing 102, from the first side 120 of the housing 102, and into an internal opening 160 of the rotary seal 106, at least until it meets the shoulder 144 of the rotary seal 106 in a force fit configuration. In some implementations, an alignment and assembly tool 600 of FIG. 6, can be used to help align and assemble the sleeve 104 with the rotary seal 106, and appropriately assemble the parts together.

As an example, a stem 602 of the alignment and assembly tool 600 can be inserted through an opening 160 at the second side 156 of the rotary seal 106, at least until a base 604 (comprising a flange) of the tool 600 meets the second side 156 of the rotary seal 106. In this implementation, the open end 606 of the stem 602 can comprise a chamfered edge 608 for easier insertion into the opening 160. Thereafter, the stem 602 can be inserted into the sleeve 104 from the second end 138 of the sleeve 104, at least until the second shoulder 136 of the sleeve 104 meets the internal shoulder 144 of the rotary seal 106. In some implementations, the coupling of the sleeve 104 with the rotary seal 106 provides a force fit, such that the two components are fixedly engaged with each other, at least until they are forced apart. As one example, a wicking-type sealant (e.g., a locking sealant) can be applied between the interface 172 of the sleeve 104 and the rotary seal 106 to provide a more secure engagement, but one that may also be selectably disengaged, such as for repair, replacement, etc. In other implementations, once the interface 172 of the sleeve 104 and the rotary seal 106 are fixedly engaged together, the combined units may not be serviceable. That is, for example, once combined, they cannot be affectively taken apart, and are thus only serviceable by replacing both units.

Additionally, the first side 154 of the rotary seal 106 can be brought into engagement with the second end 152 of the static seal 108 to provide the seal 158 between the rotary seal 106 and the static seal 108. Of note, this arrangement allows for movement of the rotary seal 106 and static seal 108 during operation, due to the clearance 166 in the pin opening 116 of the static seal 108, and the gap 168 in which the biasing spring is disposed, provided by the deflection of the biasing spring 110. Therefore, as an example, during operation, a shaft coupled to the sleeve 104 may translate up and down, which translates the rotary seal 106 up and down. Because the static seal 108 is essentially free floating in the housing cavity 170, the static seal 108 can also translate up and down while maintaining the desired seal 158 between the two components.

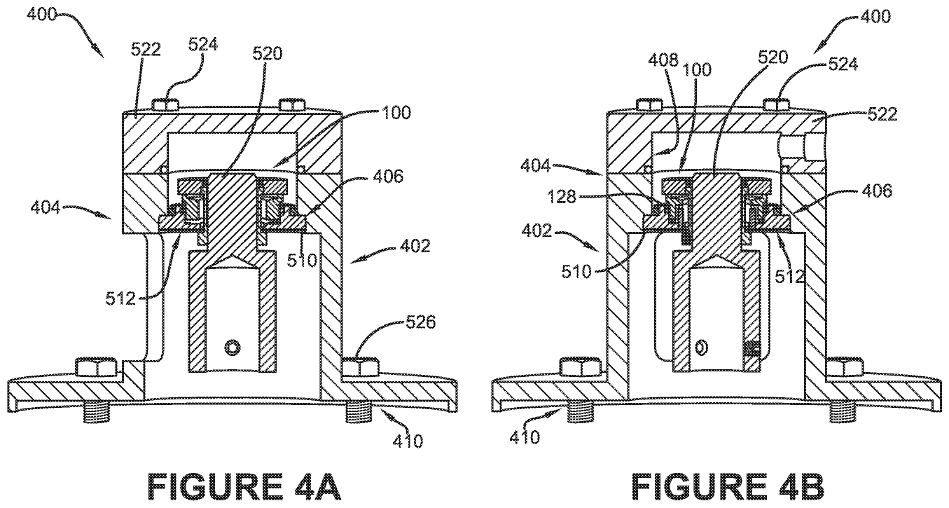

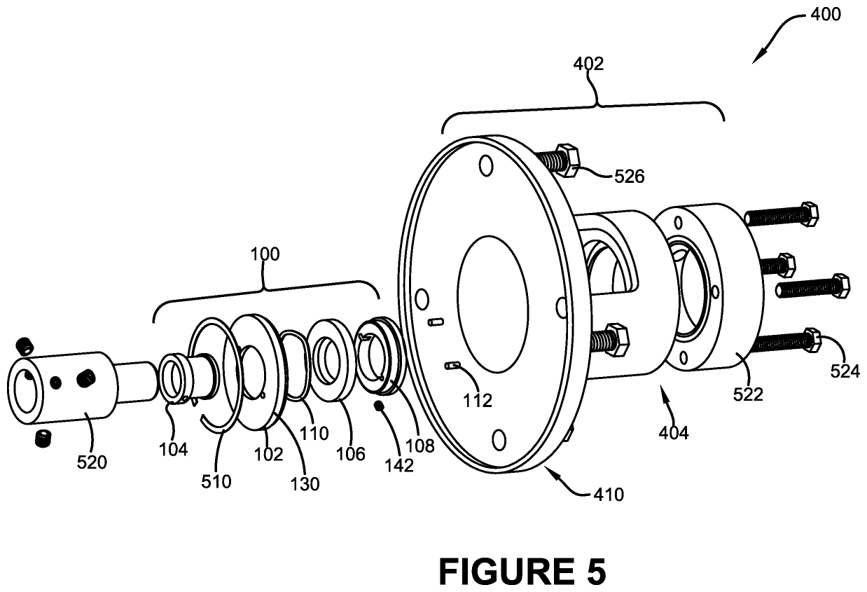

FIGS. 4A, 4B, and 5 are component diagrams that illustrate an example implementation of the seal (100) as it may be installed in a target device 400, such as a housing for a target operation, or the like. In this example implementation, the seal 100 comprises the seal housing 102, sleeve 104, rotary seal 106, static seal 108, biasing spring 110, and pins 112, along with the other components described above. In this implementation, the seal 100 can be assembled, as described above, and installed in the target device 400. As an example, as illustrated, the seal housing 102 is disposed (e.g., installed) in a portion of an upper portion 404 of the of the rotating shaft housing 402. In this example, the seal housing 102 is installed in a seat 406 that is configured (e.g., shaped and sized) to appropriately receive at least a portion of the seal housing 102 for operation. Notably, when installed, the second gasket 130 is engaged with the inside wall 408 of the upper portion 404 of the shaft housing 402 to provide a fluid seal between the seal housing 102 and the inside wall 408 of the upper portion 404 of the shaft housing 402.

In this example, once installed, the seal 100 can be effectively held in place with a retaining ring 510 that is selectably inserted into a retaining ring channel 512 disposed immediately adjacent (e.g., beneath in these figures) the installed seal housing 102. A retaining ring is typically a spring form that can be compressed to insert into the retaining channel, and when released from compression will remain in the channel during operation to hold the seal housing 102 in place. Further, in this example, a shaft coupler 520 can be installed through the sleeve 104, and held in place using the fastener 142 (e.g., a set screw or similar fastener). In this way, a shaft (not shown) can be fixedly engaged with the shaft coupler 520 (e.g., using set screws), and the shaft coupler is fixedly engaged with the sleeve 104 and rotary seal 106. As such, during operation, each of these components will rotate with the rotation of the shaft of the device. In some implementations, the fastener 142 can be accessed for fastening to the shaft coupler 520 by opening a top 522 of the upper portion 404 of the shaft housing 402. The top 522 may be selectably removed and replaced by removing one or more fasteners 524.

Additionally, as an example, the shaft housing 402 may be installed onto a portion of the target device 400, such as by fastening a lower portion 410 of the shaft housing 402 to the device, using a second set of fasteners 526.

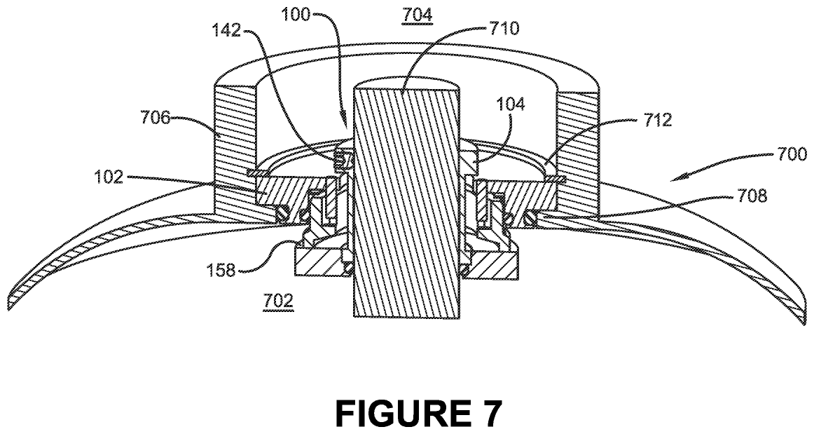

FIG. 7 is a component diagram that illustrates another example implementation of a mechanical seal, such as seal 100, installed on a target component 700, such as a mixing tank. In this implementation, a target mixing operation 702 can be sealed from the outside environment 704, such as to mitigate entry of contaminants, using the Exemplary seal 100. In this example, the target component 700 comprises a collar 706 that is configured to operably receive the housing 102 of the seal 100, to seat against a shoulder 708 of the collar 706. As described above, the second gasket 130 (static gasket) provides a seal between the collar shoulder 708 and the seal housing 102. A retaining ring 708 can be used to help secure the seal 100 in place. A rotating shaft 710 of the target component 700 is disposed in the sleeve 104, and fixedly engaged using one or more set screws (e.g., fastener 142). In this example, the shaft 710 rotates for the target mixing operation 702, which results in rotation of the sleeve 104 and engaged rotary seal 106. The seal 158, at the interface of the dynamic face 164 of the rotary seal 106 and the stationary face 166 of a static seal 108, mitigates undesired leakage (e.g., either in or out) between the operation 702 and environment 704.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A mechanical seal device for providing a fluid seal for an apparatus that uses a rotating shaft, comprising:
a seal housing comprising an annular plate body with a centrally disposed first opening, and further comprising:
a first side and a second side; and
a centrally disposed cavity at the second side that has a diameter larger than the central opening;
a static seal comprising an annular body with a centrally disposed first opening, the static seal comprising a first end and a second end, the first end engaged with a spring disposed in the central cavity of the seal housing, and the second end disposed at an opposite end of the first end, the spring operably biasing the static seal away from the seal housing;
a rotary seal comprising an annular plate body with a central opening, the rotary seal comprising a first side and a second side, the first side engaged with the second end of the static seal; and
a sleeve comprising a tube-shaped body sized to operably seat upon a shaft of a target apparatus, with a first end and second end, the second end fixedly engaged the rotary seal.

2. The device of claim 1, the seal housing comprising a second opening from the second side toward the first side that is laterally offset from the first opening.

3. The device of claim 2, the static seal comprising a second opening from the first side toward the second side that is laterally offset from the first opening.

4. The device of claim 3, comprising a pin disposed in the second opening of the seal housing and the second opening of the static seal and configured to mitigate rotational movement between the seal housing and the static seal.

5. The device of claim 1, the seal housing comprising a first gasket channel disposed at the second side, the first channel disposed on an inside wall of the seal housing.

6. The device of claim 5, the seal housing comprising a second gasket channel disposed at the second side, the second channel disposed on an outside wall of the seal housing.

7. The device of claim 6, comprising a dynamic gasket disposed in the first gasket channel, and a static gasket disposed in the second gasket channel.

8. The device of claim 1, the rotary seal comprising a third gasket channel disposed at the second side, and operably comprising a static gasket disposed therein.

9. The device of claim 1, the sleeve comprising a through opening at the first end, and comprising a fastener disposed therein configured to operably fix the sleeve to a shaft disposed therethrough the sleeve.

10. (canceled)

11. The device of claim 1, the first side of the rotary seal and the second end of the static seal respectively comprising lapped seal faces that, when engaged together, provide a fluid seal therebetween.

12. A method of making a mechanical seal device for providing a fluid seal for an apparatus that uses a rotating shaft, where the mechanical seal device comprises a seal housing, a static seal, a rotary seal, and a sleeve fixedly engaged with the rotary seal, the method comprising:
disposing a spring in a central cavity in a second side of the seal housing, which is opposite of a first side of the seal housing, wherein the seal housing comprises an annular plate body with a centrally disposed first opening;
disposing a first end of the static seal in the central cavity of the seal housing, such that the spring provides a biasing force against the first end of the static seal away from the seal housing, wherein the static seal comprises an annular body with a centrally disposed first opening;
disposing a first end of the sleeve, which is engaged with the rotary seal at a second end of the sleeve, through the centrally disposed first opening of the seal housing, wherein the rotary seal comprises an annular plate body with a central opening and having a first side and a second side, and wherein the first side of the rotary seal is engaged with the second end of the static seal to form a seal between the rotary seal and static seal.

13. The method of claim 12, wherein the seal housing comprises a second opening from the second side toward the first side that is laterally offset from the first opening, and the static seal comprises a second opening from the first side toward the second side that is laterally offset from the first opening, and wherein the method further comprises disposing a pin in the second opening of the seal housing and the second opening of the static seal that operably mitigates rotational movement between the seal housing and the static seal.

14. The method of claim 12, wherein the seal housing comprising a first gasket channel disposed at the second side, the first channel disposed on an inside wall of the seal housing, and wherein the method further comprises disposing a dynamic gasket in the first gasket channel.

15. The method of claim 12, wherein the seal housing comprises a second gasket channel disposed at the second side, the second channel disposed on an outside wall of the seal housing, and wherein the method further comprises disposing a first static gasket in the second gasket channel.

16. The method of claim 12, wherein the rotary seal comprises a third gasket channel disposed at the second side, and the method further comprising disposing a second static gasket in the third gasket channel.

17. The method of claim 12, wherein the sleeve comprises a through opening at the first end, and the method further comprises disposing a fastener therein that is operably configured to fixedly engage the sleeve to a shaft disposed therethrough the sleeve.

18. The method of claim 12, wherein using an alignment tool to align the sleeve with the rotary seal to fixedly engage the sleeve with the rotary seal, wherein the alignment tool comprises a base that is wider than the central opening of the rotary seal, and a shaft extending from the base, the shaft comprising a cylinder shape that is sized to fit through the central opening of the rotary seal and the sleeve to align the central opening of the rotary seal and the sleeve for fixed engagement.

19. A mechanical seal device for providing a fluid seal for an apparatus that uses a rotating shaft, comprising:
a seal housing comprising an annular plate body with a centrally disposed first opening, and further comprising:
a first side and a second side;
a centrally disposed cavity at the second side that has a diameter larger than the central opening;
a second opening from the second side toward the first side that is laterally offset from the first opening;
a first gasket channel disposed at the second side, the first channel disposed on an inside wall of the seal housing with a dynamic gasket disposed therein; and
a second gasket channel disposed at the second side, the second channel disposed on an outside wall of the seal housing with a first static gasket disposed therein;
a static seal comprising an annular body with a centrally disposed first opening, the static seal comprising a first end and a second end, the first end engaged with a spring disposed in the central cavity of the seal housing, and the second end disposed at an opposite end of the first end, the spring operably biasing the static seal away from the seal housing, the static seal comprising a second opening from the first side toward the second side that is laterally offset from the first opening, and having a pin disposed therein that is operably disposed in the second opening of the seal housing;
a rotary seal comprising an annular plate body with a central opening, the rotary seal comprising a first side and a second side, the first side engaged with the second end of the static seal, the rotary seal comprising a third gasket channel with a second static gasket disposed therein; and
a sleeve comprising a tube-shaped body sized to operably seat upon a shaft of a target apparatus, with a first end and second end, the second end fixedly engaged the rotary seal.

20. The device of claim 19, wherein the first side of the rotary seal and the second end of the static seal respectively comprising lapped seal faces that, when engaged together, provide a fluid seal therebetween.

21. The device of claim 1, wherein the first end of the sleeve is disposed through the seal housing and the spring is positioned around the tube-shaped body of the sleeve.
